(19) United States
(12) Patent Application Publication
(10) Pub. No.: US 2026/0330550 A1
(43) Pub. Date: Oct. 22, 2026

(54) HARDWARE-ATTESTED ADVERSARIAL PREDICTION MARKET SURVEILLANCE SYSTEM

(71) Applicant: George William Bickerstaff, III, Greenwich, CT (US)

(72) Inventor: George William Bickerstaff, III, Greenwich, CT (US)

(21) Appl. No.: 19/713,834

(22) Filed: Jun. 19, 2026

(51) Int. Cl. G06Q 40/04; H04L 9/00

(52) U.S. Cl. CPC G06Q 40/046; G06Q 40/0525; H04L 9/50; G06Q 2220/00

(57) ABSTRACT

A hardware-attested system performs adversarial integrity surveillance of multi-exchange prediction markets within a Trusted Execution Environment. The system ingests consolidated cross-venue attestation records, validates them, and maintains a rolling behavioral state comprising a participant identity graph, a calibrated probability surface, a venue microstructure history, and a cross-venue coordination index. An ensemble of at least six behavioral classifiers detects wash trading, coordinated inauthentic activity, probability manipulation, liquidity spoofing, cross-venue Sybil attacks, and insider trading, with a multi-classifier correlation boost applied when three or more classifiers flag a common participant. High-confidence detections yield cryptographically sealed adversarial alert records bound to platform and surveillance-system attestation quotes, zero-knowledge regulatory reports with credential-gated selective disclosure, and signed circuit-breaker recommendations to an orchestration system retaining decisional authority. Outputs are independently verifiable by a regulator without reliance on the venue operator.

### CROSS-REFERENCE TO RELATED APPLICATIONS

This application claims the benefit of U.S. Provisional Application No. 64/046,157, filed Apr. 22, 2026, the entire contents of which are incorporated herein by reference. This application is related to commonly-owned co-pending applications directed to companion systems including a hardware-attested trade integrity system, a verified prediction confidence scoring engine, a regulatory-compliant wrapper system, a federated stack orchestrator, a multi-exchange consolidated surveillance and probability fusion platform, and a resolution-outcome oracle, the contents of which are incorporated herein by reference to the extent consistent herewith.

### FIELD OF THE INVENTION

The present invention relates to hardware-secured financial market surveillance systems, and more particularly to a hardware-attested, artificial-intelligence-driven system that ingests consolidated cross-venue attestation output from a multi-exchange consolidated prediction market platform and performs adversarial integrity surveillance within a Trusted Execution Environment, producing cryptographically verifiable adversarial alert records, privacy-preserving regulatory reports, and circuit-breaker action recommendations.

### BACKGROUND OF THE INVENTION

Prediction markets have emerged as a rapidly growing class of derivative financial instruments enabling participants to take positions on the outcomes of future events. As participation and notional volumes have grown, these venues have become subject to the same categories of market-integrity threats long recognized in traditional regulated financial markets, including wash trading, coordinated inauthentic activity, probability manipulation, liquidity spoofing, cross-venue identity multiplication, and trading on material non-public information.

Contemporary regulatory attention has intensified accordingly. Market oversight authorities have issued advisory guidance and advanced rulemaking concerning surveillance obligations for prediction market venues, and major venues have announced voluntary market-integrity enhancements. Existing prediction market platforms, however, generally lack adversarial integrity surveillance capabilities commensurate with regulated financial market standards, and in particular lack mechanisms by which a regulator or institutional counterparty can independently verify that surveillance was performed correctly, on unaltered inputs, by unmodified code, without relying on the representations of the venue operator.

Software-only surveillance systems cannot provide such independent verifiability: their outputs depend on the integrity of the operator's infrastructure and afford a relying party no cryptographic means of confirming which code processed which inputs. A clear need exists for a hardware-attested adversarial prediction market integrity surveillance system that ingests consolidated cross-venue attestation streams, performs ensemble adversarial detection within a hardware-protected enclave, and emits tamper-evident, privacy-preserving, independently verifiable outputs. The present invention addresses this need.

### SUMMARY OF THE INVENTION

The present invention provides a hardware-attested multi-exchange adversarial prediction market integrity surveillance system, designated APAMIS, comprising a Trusted Execution Environment (TEE)-anchored behavioral analysis core; an attestation ingestion interface; an ensemble adversarial classifier pipeline comprising at least six behavioral classifiers; an ensemble scoring module implementing a multi-classifier correlation boost; a cryptographic alert sealing subsystem; a zero-knowledge regulatory reporting engine; a circuit-breaker interface; and an adaptive classifier governance module.

In one embodiment, APAMIS receives a consolidated multi-exchange attestation stream comprising a platform master attestation quote, per-venue hardware attestation quotes, an inverse-variance-weighted probability fusion output, and a cross-exchange consistency score; validates each record within the TEE; maintains a rolling behavioral state comprising a participant identity graph, a calibrated probability surface, a venue microstructure history, and a cross-venue coordination index; applies the ensemble classifier pipeline; computes an ensemble adversarial alert score with a multi-classifier correlation boost; and, upon a high-confidence determination, generates a cryptographically sealed adversarial alert record bound to the platform master attestation quote and to a TEE remote attestation quote of the surveillance system.

In further embodiments, APAMIS generates zero-knowledge regulatory submissions in which participant identities are represented as cryptographic commitments with enforcement-credential-gated selective disclosure, and transmits signed circuit-breaker action recommendations to a prediction market orchestration system that retains decisional authority over execution. The combination of hardware-sealed processing, TEE-bound computation, and cryptographic attestation produces surveillance outputs whose input-record integrity and methodological integrity are independently verifiable by a third party.

### BRIEF DESCRIPTION OF THE DRAWINGS

FIG. 1 depicts the overall APAMIS system architecture and its external interfaces, in subfigures FIG. 1A through FIG. 1E.

FIG. 2 depicts the TEE-anchored behavioral analysis core and attestation ingestion, in subfigures FIG. 2A through FIG. 2E.

FIG. 3 depicts the six-classifier ensemble pipeline and ensemble scoring, in subfigures FIG. 3A through FIG. 3E.

FIG. 4 depicts cryptographic alert sealing and zero-knowledge regulatory reporting, in subfigures FIG. 4A through FIG. 4E.

FIG. 5 depicts the circuit-breaker interface and adaptive classifier governance, in subfigures FIG. 5A through FIG. 5E.

### DETAILED DESCRIPTION OF PREFERRED EMBODIMENTS

### Definitions

As used herein, the following terms have the meanings set forth below. The definitions are inclusive and non-limiting; each term includes, but is not limited to, the described subject matter.

“Account-Linkage Fingerprint” means a cryptographic feature representation derived from order-flow and account-metadata records and used to identify groupings of accounts exhibiting common control or coordination, including but not limited to hashed funding-source identifiers and temporal-pattern vectors.

“Adversarial Alert Record” means a data structure generated within the Trusted Execution Environment that binds a detected adversarial event to a platform master attestation quote and to a remote attestation quote of the surveillance system, including but not limited to confidence levels, contributing event types, and participant identity commitments.

“Attestation Ingestion Interface” means a component configured to receive and validate consolidated multi-exchange attestation records within the Trusted Execution Environment, including but not limited to signature, freshness, consistency, and completeness validation.

“Calibrated Probability Surface” means a maintained representation of calibrated probability estimates over listed event contracts, derived from attestation output produced by a verified prediction calibration system, including but not limited to per-contract calibrated values updated upon each received calibrated probability attestation.

“Confidential Virtual Machine” means a hardware-protected virtual machine providing memory encryption, isolation, and remote attestation under control of a cloud-provider or platform attestation service, including but not limited to confidential-computing virtual machine offerings supporting hardware-rooted measurement.

“Cross-Venue Coordination Index” means a maintained representation, including but not limited to a sliding-window correlation matrix, of position-change relationships among participants observed on two or more venues.

“Ensemble Adversarial Alert Score” means a scalar score computed from classifier-specific confidence scores together with a multi-classifier correlation boost, including but not limited to weighted aggregations thereof.

“Hardware Measurement Register” means a hardware-protected register whose contents cryptographically bind to a measured code base upon instantiation, including but not limited to platform configuration registers and equivalent measurement facilities.

“Multi-Classifier Correlation Boost” means an additive term applied to the ensemble adversarial alert score when three or more behavioral classifiers generate candidate events for a common participant entity or cluster within a common temporal window, including but not limited to terms scaling with the number of concurrently active classifiers.

“Participant Identity Graph” means a directed weighted graph maintained within the Trusted Execution Environment in which vertices represent participant identities expressed as cryptographic commitments and edges carry rolling transaction-volume weights, including but not limited to Pedersen-commitment representations.

“Selective Disclosure Package” means a credential-gated data structure enabling an authorized regulatory recipient to recover committed participant identity values, including but not limited to encryptions under a registered enforcement public key subject to credential-revocation verification.

“Trusted Execution Environment (TEE)” means a hardware-protected execution environment providing measurement, isolation, and remote attestation, including but not limited to Intel SGX, Intel TDX, AMD SEV-SNP, ARM CCA, and confidential virtual machine substrates.

“Venue Microstructure History” means a maintained record of order lifecycle events for each venue and contract, including but not limited to a hash-chained buffer of order placement, modification, cancellation, and execution events recorded with monotonic timestamps.

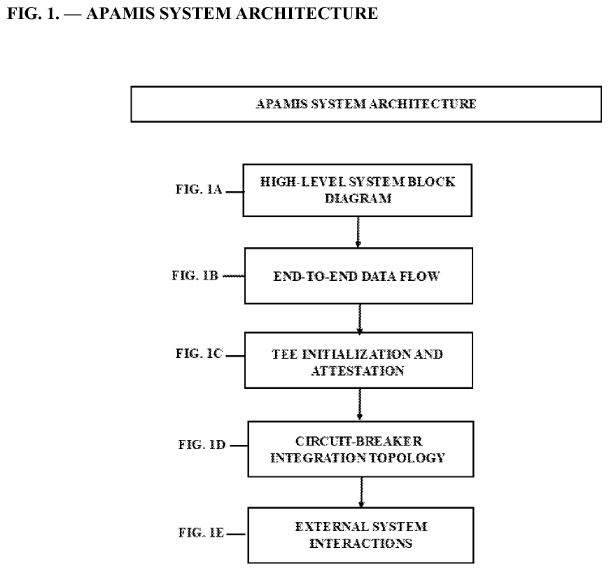

I. System Architecture Overview. APAMIS is organized as a set of cooperating modules executing within one or more Trusted Execution Environments, anchored to an upstream multi-exchange consolidated prediction market platform, and producing outputs to three downstream consumers: a regulatory reporting endpoint, a circuit-breaker interface of a prediction market orchestration system, and an immutable append-only audit log. The system modules comprise an attestation ingestion interface; a TEE-anchored behavioral analysis core; an ensemble adversarial classifier pipeline comprising a wash trading detector, a coordinated inauthentic prediction activity detector, a probability manipulation detector, a liquidity spoofing detector, a cross-venue Sybil attack detector, and an insider trading detector; an ensemble scoring module implementing a multi-classifier correlation boost; a cryptographic alert sealing subsystem; a zero-knowledge regulatory reporting engine; a circuit-breaker interface; and an adaptive classifier governance module. The overall architecture is depicted in FIG. 1. The end-to-end data flow from the upstream multi-exchange consolidated prediction market platform, through the surveillance modules, to the downstream regulatory reporting endpoint, circuit-breaker interface, and immutable audit log is depicted in FIG. 1B.

II. TEE-Anchored Behavioral Analysis Core. The behavioral analysis core executes within a hardware-protected enclave supporting remote attestation, sealed storage, and runtime memory encryption. In preferred embodiments the enclave is instantiated on Intel SGX, Intel TDX, AMD SEV-SNP, ARM CCA, or a cloud-provider confidential virtual machine supporting hardware remote attestation. At system initialization the enclave measures all loaded classifier pipeline module binaries, ensemble scoring code, cryptographic primitives, and reporting-engine code into one or more hardware measurement registers, and invokes a hardware attestation service to generate a system root attestation quote signed by a hardware manufacturer's attestation key, which is included in all outbound records. The TEE initialization workflow is depicted in FIG. 1C.

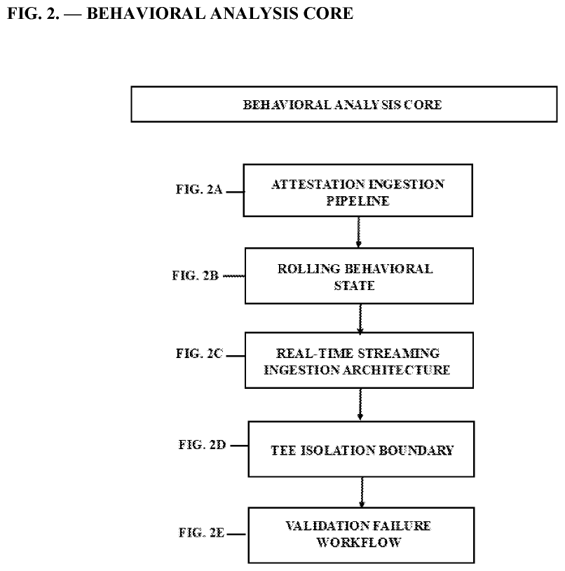

II.A. Rolling Behavioral State. The behavioral analysis core maintains within encrypted enclave memory a rolling behavioral state comprising: (a) a participant identity graph structured as a directed weighted graph in which each vertex represents a participant identity expressed as a Pedersen commitment and each edge carries a rolling probability-normalized transaction-volume weight aggregated over a configurable temporal window; (b) a calibrated probability surface defined over listed event contracts and derived from attestation output produced by a verified prediction calibration system; (c) a venue microstructure history comprising, for each venue and contract, a hash-chained ring buffer of order lifecycle events recorded with monotonic timestamps; and (d) a cross-venue coordination index comprising a sliding-window correlation matrix over position-change time series for participants observed on two or more venues. All updates are computed incrementally within the TEE without exposing state to the host operating system. The rolling behavioral state is depicted in FIG. 2B and the TEE isolation boundary in FIG. 2D.

III. Attestation Ingestion and Validation Pipeline. The attestation ingestion interface receives consolidated multi-exchange attestation records, each comprising a platform master attestation quote, per-venue hardware attestation quotes, an inverse-variance-weighted fused probability estimate for each cross-listed contract, a cross-exchange consistency score, a venue completeness ratio, and a monotonic timestamp. Upon receipt the interface validates, within the TEE: the platform master attestation quote against a provisioned root public key; each per-venue quote against the corresponding venue root public key; timestamp freshness against a freshness threshold; the consistency score against a minimum consistency threshold; and the completeness ratio against a minimum completeness threshold. Records failing any check are rejected with a validation-failure event. When the rolling validation-failure rate over a sliding window exceeds a configurable degradation threshold, the interface emits a cryptographically signed administrative-degradation notification. The ingestion pipeline is depicted in FIG. 2A and the validation-failure workflow in FIG. 2E.

In a real-time streaming ingestion architecture, depicted in FIG. 2C, consolidated multi-exchange attestation records are received as a continuous stream rather than in discrete batches, and are processed incrementally within the Trusted Execution Environment as each record arrives. Each arriving record is validated, and upon successful validation the rolling behavioral state—comprising the participant identity graph, the calibrated probability surface, the venue microstructure history, and the cross-venue coordination index—is updated incrementally within the enclave without reprocessing previously ingested records and without exposing intermediate state to the host operating system. The streaming architecture maintains a bounded-latency processing pipeline in which validated records are passed to the ensemble adversarial classifier pipeline as they are admitted, such that adversarial detections and the associated ensemble adversarial alert scores are produced in substantially real time relative to the underlying trading activity. Backpressure and admission control within the streaming pipeline ensure that records exceeding the freshness, consistency, or completeness thresholds are rejected at intake and do not enter the incremental update path.

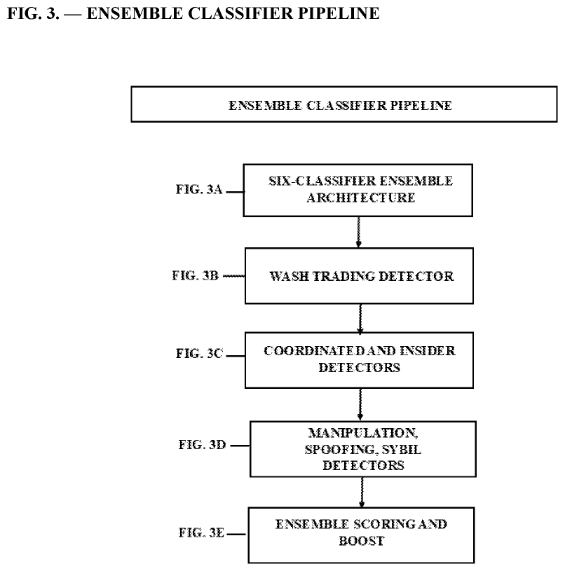

IV. Six-Classifier Ensemble Pipeline. The ensemble adversarial classifier pipeline comprises at least six behavioral classifiers operating in parallel on validated records and the current rolling behavioral state, each producing, for each candidate participant entity or cluster and observation window, a candidate event and a classifier-specific confidence score in the interval from zero to one. The pipeline architecture is depicted in FIG. 3A.

IV.A. Wash Trading Detector. The wash trading detector applies a cycle-detection algorithm over the participant identity graph restricted to a rolling temporal window. For each directed cycle completing within a configurable maximum cycle-completion time, the detector computes the net probability exposure change aggregated over the cycle and the cycle completion time, and generates a wash trading candidate event when the absolute net exposure change falls below a minimum-significance threshold and the completion time falls below the maximum. The confidence score increases with the margin below the significance threshold and with the inverse of the completion time. The wash trading detector is depicted in FIG. 3B.

IV.B. Coordinated Inauthentic Prediction Activity Detector. The coordinated inauthentic prediction activity detector applies a community detection algorithm, in preferred embodiments the Louvain method or a modularity-optimizing equivalent, to the participant identity graph, and for each community exceeding a minimum size computes mean pairwise position-change correlation, an inter-member temporal lag distribution, and cross-venue position-change correlation, generating a candidate event when the correlation exceeds a first threshold, the fraction of position changes with inter-member lag below a second threshold exceeds a third threshold, and the cross-venue correlation exceeds a fourth threshold. This detector is depicted in FIG. 3C.

IV.C. Probability Manipulation Detector. The probability manipulation detector computes, for each event contract, a real-time distortion magnitude equal to the absolute difference between the inverse-variance-weighted fused probability estimate and the corresponding calibrated probability surface value, generating a candidate event when the distortion exceeds a distortion threshold and persists beyond a persistence window, with confidence weighted by directional alignment between the distortion direction and a flagged participant's net position-change direction. This detector is depicted in FIG. 3D.

IV.D. Liquidity Spoofing Detector. The liquidity spoofing detector operates on the venue microstructure history and computes, for each participant, a cancel-before-fill rate, a pre-cancellation order book depth impact, and a post-cancellation probability price mean reversion statistic, generating a candidate event when each exceeds its corresponding detection threshold, with confidence computed as a weighted geometric mean of the three statistics normalized by their thresholds. This detector is depicted in FIG. 3D.

IV.E. Cross-Venue Sybil Attack Detector. The cross-venue Sybil attack detector constructs a behavioral fingerprint vector for each participant identity, comprising an order timing distribution signature, a position sizing distribution signature, a market selection preference vector, and a response latency signature, and generates a candidate event for identity pairs exhibiting cosine similarity above a similarity threshold across all fingerprint dimensions and non-overlapping activity windows on two or more venues. This detector is depicted in FIG. 3D.

IV.F. Insider Trading Detector. The insider trading detector maintains an information-release event timeline and, for each information-release event, evaluates a pre-release and a post-release window, computing for each participant or cluster an anomaly score normalized to a baseline distribution of position changes for similarly situated participants, and generating a candidate event when the anomaly score exceeds an anomaly threshold and exhibits directional alignment with the eventual information-release direction, with confidence weighted by inferred participant proximity to an information source. Consistent with the companion-system architecture, raw trade-integrity signals are generated by a companion trade integrity system and a calibrated insider-risk indicator is computed by a companion verified prediction confidence scoring engine; APAMIS consumes such signals as received input and does not itself compute the calibrated insider-risk indicator. This detector is depicted in FIG. 3C.

### V. Ensemble Scoring and Multi-classifier Correlation Boost. the Ensemble Scoring

module computes, for each participant entity or cluster and each observation window, an ensemble adversarial alert score equal to a weighted sum of classifier-specific confidence scores for classifiers whose scores exceed classifier-specific thresholds, plus a multi-classifier correlation boost term applied when three or more classifiers generate candidate events for a common participant entity or cluster within a common temporal window, the boost term scaling with the number of concurrently active classifiers raised to a boost-scaling exponent. Classifier weights, thresholds, boost constants, and the high-confidence threshold are measured into a hardware measurement register at enclave initialization. When the score meets or exceeds the high-confidence threshold, the module requests generation of a sealed adversarial alert record. Ensemble scoring is depicted in FIG. 3E.

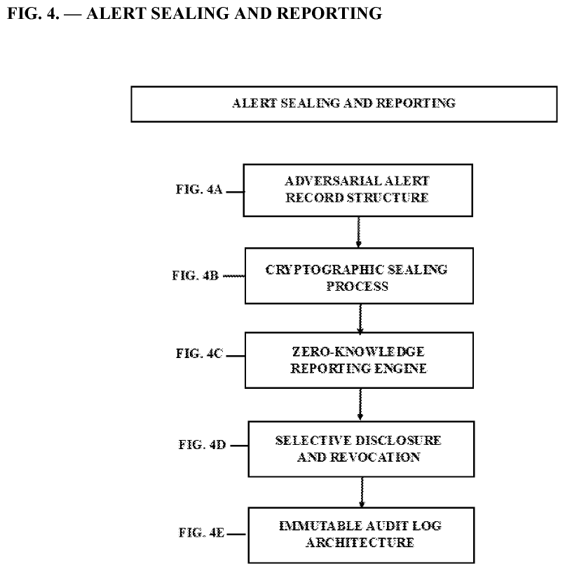

VI. Cryptographic Alert Sealing Subsystem. The cryptographic alert sealing subsystem generates within the TEE an adversarial alert record comprising an alert record identifier, an alert confidence level, contributing adversarial event types with per-classifier confidence scores, the ensemble score, affected venue identifiers, a temporal evidence window, Pedersen commitments to affected participant identity values, the platform master attestation quote from the triggering record, a TEE remote attestation quote of the surveillance system, and a hash-based message authentication code computed over the preceding fields with a key sealed within the TEE and accessible only to the current enclave measurement. Each sealed record is appended to an immutable append-only audit log protected by TEE-verified hash chaining, and the enclave periodically publishes a signed audit-log root to an externally verifiable bulletin or consortium distributed ledger, the root being anchorable to a public blockchain at a configurable cadence. The alert record structure is depicted in FIG. 4A, the sealing process in FIG. 4B, and the audit-log architecture in FIG. 4E.

VII. Zero-Knowledge Regulatory Reporting Engine. The zero-knowledge regulatory reporting engine generates regulatory submissions in which participant identities are represented as Pedersen commitments, each report comprising the alert record identifier and confidence level, aggregate statistics over the affected participant cluster, a zero-knowledge proof that the aggregate statistics are correctly computed from the committed identity values, and the TEE remote attestation quote. In preferred embodiments the engine additionally produces a selective disclosure package encrypting each participant identity value and Pedersen opening randomness under a regulatory authority's registered enforcement public key, gated such that the engine verifies a valid, non-revoked enforcement credential against a governance-authority-signed credential revocation list prior to transmission. The reporting engine is depicted in FIG. 4C and selective disclosure in FIG. 4D.

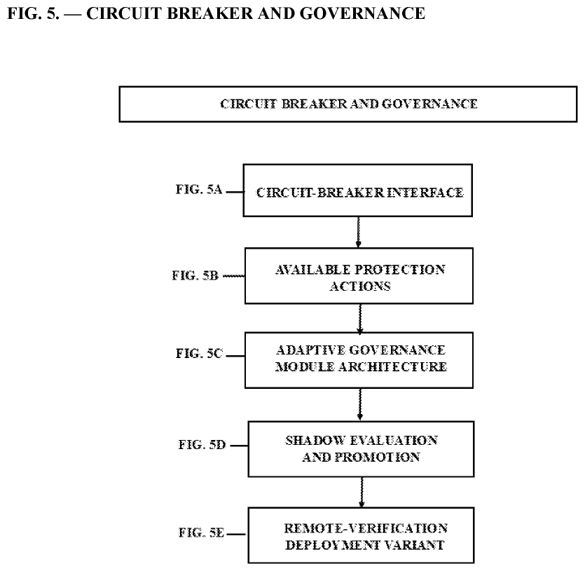

VIII. Circuit-Breaker Interface. The circuit-breaker interface transmits to a prediction market orchestration system a signed action recommendation record comprising the adversarial alert record identifier, a recommended action selected from market suspension, participant order rejection, enhanced monitoring activation, and liquidity protection activation, the underlying confidence level, the TEE remote attestation quote, and a signature computed with a TEE-sealed signing key. The orchestration system retains decisional authority over execution, treats the recommendation as an advisory input subject to its policies, and logs the recommendation and its disposition in a hardware-attested audit trail. The interface is depicted in FIG. 5A and available actions in FIG. 5B.

IX. Adaptive Classifier Governance Module. The adaptive classifier governance module enables evolution of the classifier pipeline while preserving hardware-attested integrity. Classifier update packages comprise classifier binaries, updated parameters, and a manifest hash; upon receipt the module verifies a multi-signature quorum and the manifest hash, then instantiates the candidate classifier in a shadow evaluation context that receives the same validated records as production but produces no production effect, accumulating performance metrics over a configurable shadow evaluation period. Upon completion the module generates a signed governance report, and the candidate is promoted only upon a promotion approval satisfying a promotion multi-signature threshold, each promotion appended to an immutable governance audit log. The governance architecture is depicted in FIG. 5C and the shadow-evaluation workflow in FIG. 5D.

### Enablement Examples

Example 1 (single-vendor SGX deployment). Consider a single regulated prediction market venue whose surveillance is performed by an APAMIS instance executing within an Intel SGX enclave on the venue operator's infrastructure. At initialization, the enclave measures the classifier pipeline binaries, ensemble scoring code, and cryptographic primitives into a measurement register MR=0x9F3C . . . and generates a root attestation quote via the Intel Data Center Attestation Primitives service. The attestation ingestion interface receives a consolidated record bearing a platform master quote, a single per-venue quote, a fused probability estimate P_fused=0.62 for a listed event contract, a consistency score S_cons=0.98 (threshold theta_cons=0.95), and a completeness ratio rho_ven=1.00 (threshold theta_ven=0.90); validation passes. The rolling behavioral state is updated, and the ensemble pipeline flags a four-account grouping: the wash trading detector reports net exposure change |DeltaP_net|=0.004 below sigma_wash=0.01 (c_wash=0.71); the coordinated-activity detector reports pairwise correlation 0.93 above theta_1=0.85 (c_coord=0.80); and the probability manipulation detector reports distortion D=0.17 above theta_D=0.10 persisting beyond tau_D (c_pm=0.66). With three classifiers active for a common cluster, the correlation boost applies: E=(0.4) (0.71)+(0.35)(0.80)+(0.25)(0.66)+beta*3\hat{ }gamma, with beta=0.05 and gamma=1.0 yielding E approximately 0.81, exceeding Theta_high =0.75. A sealed adversarial alert record is generated, HMAC-SHA256 authenticated under the TEE-sealed key, appended to the audit log, and a circuit-breaker recommendation of enhanced monitoring activation is transmitted; the venue orchestration system logs the recommendation and defers execution for human review. A relying regulator independently verifies the alert by checking the surveillance system's remote attestation quote against the Intel attestation service, without reliance on the venue operator.

Example 2 (multi-vendor cross-venue federation). Consider three venues operating heterogeneous Trusted Execution Environments—a first on Intel TDX, a second on AMD SEV-SNP, and a third on ARM CCA—whose per-venue attestation quotes are consolidated by an upstream multi-exchange consolidated prediction market platform and delivered to an APAMIS instance configured with a multi-vendor attestation federation policy provisioned at enclave initialization. The attestation ingestion interface verifies each per-venue quote against its respective hardware-vendor attestation service under the federation policy and verifies the platform master quote, accepting the consolidated record only when all three vendor chains validate and the cross-exchange consistency score and completeness ratio satisfy their thresholds. The cross-venue Sybil attack detector constructs behavioral fingerprint vectors and identifies an identity pair with cosine similarity 0.97 above theta_sim=0.90 across all fingerprint dimensions and non-overlapping activity windows on the TDX and SEV-SNP venues, while the insider trading detector consumes a calibrated insider-risk indicator received from the companion verified prediction confidence scoring engine and reports an anomaly score of 3.4 standard deviations exceeding theta_anom=3.0 with directional alignment to a subsequent information-release event. Two classifiers active across venues yield an ensemble score below Theta_high absent a third; upon a third venue's liquidity spoofing detection for the same cluster, the multi-classifier correlation boost raises E above Theta_high, a sealed alert record binds the platform master quote and the APAMIS remote attestation quote, and a zero-knowledge regulatory report is generated with participant identities as Pedersen commitments and a selective disclosure package gated to a regulator holding a valid, non-revoked enforcement credential. The report is verifiable by a recipient that does not itself instantiate a Trusted Execution Environment.

Example 3 (confidential-VM deployment; institutional counterparty as relying party). Consider a deployment in which APAMIS executes within a cloud-provider confidential virtual machine and the relying party is an institutional counterparty rather than a regulator. At enclave initialization the confidential virtual machine measures the surveillance code base into a measurement register and obtains a root attestation quote from the cloud provider's attestation service. APAMIS ingests a consolidated record spanning four venues; the cross-venue Sybil attack detector and the coordinated inauthentic prediction activity detector each flag a common participant cluster, and the liquidity spoofing detector flags the same cluster, yielding three concurrently active classifiers. The multi-classifier correlation boost term, computed as beta multiplied by the number of active classifiers raised to the boost-scaling exponent (here beta=0.05, exponent=1.2, three classifiers), raises the ensemble adversarial alert score above the high-confidence threshold even though no single classifier-specific confidence score is individually decisive. A sealed adversarial alert record and a signed circuit-breaker action recommendation of liquidity protection activation are produced; the orchestration system effects the protective response, producing a concrete technical effect upon market operation. The institutional counterparty, holding no enforcement credential, receives the zero-knowledge regulatory report and verifies the surveillance system's remote attestation quote against the cloud provider's attestation service and the aggregate-statistics proof, thereby relying on the integrity of the surveillance output in a downstream risk decision without itself instantiating a Trusted Execution Environment and without reliance on the venue operator. This example demonstrates enablement across the claimed range of relying parties and across a confidential-virtual-machine substrate distinct from the enclave substrates of Examples 1 and 2.

X. Alternative Embodiments. The system supports additional TEE implementations and multi-vendor attestation federation in which heterogeneous platform quotes are verified against a federation policy provisioned at enclave initialization. Sealed alert hashes may be anchored on a public blockchain or consortium distributed ledger at a configurable cadence; batch forensic modes may operate on archived records; the behavioral analysis core and classifier pipeline may execute in distinct mutually attested TEEs; the alert sealing subsystem may be replicated across TEEs for high availability; and the reporting engine may generate reports compatible with multiple regulatory schemas, each accompanied by a schema identifier and a proof of correct aggregate computation. In a remote-verification configuration, adversarial alert records and zero-knowledge regulatory reports are provided as cryptographically verifiable artifacts to venues or regulators without requiring the recipient to instantiate a Trusted Execution Environment. The disclosure herein supports, and the applicant reserves the right to pursue in one or more continuation or divisional applications, claims of broader or differing scope, including without limitation claims directed to adversarial integrity surveillance of regulated electronic markets generally, claims directed to the relying-party verification operations described herein independent of the prediction-market context, and claims directed to the multi-classifier correlation boost mechanism as applied to other ensemble-detection settings. The foregoing embodiments are illustrative and non-limiting.

What is claimed is:

1. A hardware-attested multi-exchange adversarial prediction market integrity surveillance system, comprising: a Trusted Execution Environment (TEE)-anchored behavioral analysis core executing within a hardware-protected enclave, the hardware-protected enclave having a hardware measurement register binding a measured surveillance code base upon instantiation and a hardware-rooted attestation key; an attestation ingestion interface configured to receive and validate, within the TEE, consolidated multi-exchange attestation records from a multi-exchange consolidated prediction market platform, each consolidated attestation record comprising a platform master attestation quote, a set of per-venue hardware attestation quotes, an inverse-variance-weighted probability fusion output, and a cross-exchange consistency score, said consolidated multi-exchange attestation records being received as input from the multi-exchange consolidated prediction market platform; the behavioral analysis core being configured to maintain, within the TEE, a rolling behavioral state comprising a participant identity graph, a calibrated probability surface, a venue microstructure history, and a cross-venue coordination index; an ensemble adversarial classifier pipeline comprising at least six behavioral classifiers operating on validated consolidated attestation records, the at least six behavioral classifiers comprising a wash trading detector, a coordinated inauthentic prediction activity detector, a probability manipulation detector, a liquidity spoofing detector, a cross-venue Sybil attack detector, and an insider trading detector, each behavioral classifier being configured to generate a candidate event and a classifier-specific confidence score; an ensemble scoring module configured to compute an ensemble adversarial alert score from the classifier-specific confidence scores and to add to said ensemble adversarial alert score a multi-classifier correlation boost term, computed only when three or more of the behavioral classifiers generate candidate events for a common participant entity or cluster within a common temporal window, the multi-classifier correlation boost term having a magnitude that scales with a number of concurrently active behavioral classifiers raised to a boost-scaling exponent of at least one, such that the ensemble adversarial alert score for said common participant entity or cluster exceeds an arithmetic sum of the corresponding classifier-specific confidence scores; a cryptographic alert sealing subsystem configured to generate, within the TEE and upon the ensemble adversarial alert score meeting or exceeding a high-confidence threshold, an adversarial alert record binding a detected adversarial event to the platform master attestation quote of the triggering consolidated attestation record and to a TEE remote attestation quote of the surveillance system; a zero-knowledge regulatory reporting engine configured to generate regulatory submissions comprising adversarial event evidence with participant identities represented as cryptographic commitments and to generate selective disclosure packages accessible only to regulatory recipients possessing valid, non-revoked enforcement credentials; and a circuit-breaker interface configured, upon the ensemble adversarial alert score meeting or exceeding the high-confidence threshold, to transmit to a prediction market orchestration system a signed action recommendation record that causes the prediction market orchestration system to effect an automated market protection response selected from the group consisting of market suspension, participant order rejection, enhanced monitoring activation, and liquidity protection activation, whereby a detected adversarial event produces a concrete technical effect upon operation of the prediction market.

2. A computer-implemented method for adversarial integrity surveillance of multi-exchange prediction market networks, comprising: generating, within a Trusted Execution Environment (TEE) instantiated in a hardware-protected enclave having a hardware measurement register and a hardware-rooted attestation key, a TEE remote attestation quote of a surveillance system and binding the TEE remote attestation quote to outputs of the surveillance system; receiving, within the TEE, a consolidated multi-exchange attestation stream from a multi-exchange consolidated prediction market platform, the attestation stream comprising per-venue hardware attestation quotes and an inverse-variance-weighted probability fusion output; verifying, within the TEE, a platform master attestation quote and the per-venue hardware attestation quotes of each attestation record, and validating each attestation record against an attestation integrity requirement, a cross-exchange consistency score threshold, a timestamp freshness requirement, and a venue completeness requirement; maintaining, within the TEE, a rolling behavioral state comprising a participant identity graph, a calibrated probability surface, a venue microstructure history, and a cross-venue coordination index; applying an ensemble adversarial classifier pipeline comprising at least six behavioral classifiers to validated attestation records, each classifier generating a candidate event with a classifier-specific confidence score; computing an ensemble adversarial alert score from the classifier-specific confidence scores and adding a multi-classifier correlation boost term when three or more classifiers generate candidate events for a common participant entity or cluster within a common temporal window, the boost term scaling with a number of concurrently active classifiers raised to a boost-scaling exponent of at least one; upon the ensemble adversarial alert score meeting or exceeding a high-confidence threshold, generating within the TEE a cryptographically sealed adversarial alert record comprising participant identity commitments, adversarial event evidence, a platform attestation binding, and the TEE remote attestation quote of the surveillance system; transmitting the sealed adversarial alert record to a regulatory reporting endpoint; and transmitting to a circuit-breaker interface of a prediction market orchestration system a signed action recommendation record causing the prediction market orchestration system to effect an automated market protection response, whereby a detected adversarial event produces a concrete technical effect upon operation of the prediction market.

3. A non-transitory computer-readable medium storing instructions that, when executed within a Trusted Execution Environment (TEE) instantiated in a hardware-protected enclave having a hardware measurement register and a hardware-rooted attestation key, cause a hardware-attested adversarial prediction market integrity surveillance system to perform operations comprising: generating, within the TEE, a TEE remote attestation quote of the surveillance system and binding the TEE remote attestation quote to outputs of the surveillance system; ingesting a consolidated multi-exchange attestation stream from a multi-exchange prediction market consolidation platform; executing an ensemble adversarial classifier pipeline comprising at least six behavioral classifiers within the TEE against the consolidated attestation stream; computing an ensemble adversarial alert score and adding a multi-classifier correlation boost term when three or more classifiers flag a common participant entity or cluster within a common temporal window; upon the ensemble adversarial alert score meeting or exceeding a high-confidence threshold, generating within the TEE cryptographically sealed adversarial alert records binding detected adversarial events to a platform master attestation quote and to the TEE remote attestation quote of the surveillance system; generating zero-knowledge-compatible regulatory submissions in which participant identities are represented as cryptographic commitments with enforcement-selective disclosure accessible only to regulatory recipients possessing valid, non-revoked enforcement credentials; and transmitting to a circuit-breaker interface of a prediction market orchestration system a signed action recommendation record causing an automated market protection response.

4. The system of claim 1, wherein the boost-scaling exponent and a boost-magnitude constant defining the multi-classifier correlation boost term are measured into the hardware measurement register at enclave initialization and are subject to adaptive governance, such that the multi-classifier correlation boost term cannot be altered without producing a different hardware measurement register value.

5. The system of claim 1, wherein the wash trading detector applies a cycle-detection algorithm over the participant identity graph restricted to a rolling temporal window, and wherein, for each directed cycle completing within a configurable maximum cycle-completion time, the wash trading detector generates a wash trading candidate event when the absolute value of the net probability exposure change aggregated over the cycle falls below a minimum-significance threshold, and the classifier-specific confidence score is computed as a function of the difference between the minimum-significance threshold and the absolute net probability exposure change and the inverse of the cycle completion time.

6. The system of claim 1, wherein the coordinated inauthentic prediction activity detector applies a community detection algorithm to the participant identity graph to identify participant communities exhibiting (i) mean pairwise position-change correlation above a first threshold, (ii) inter-member temporal lag of position changes below a second threshold across a minimum fraction of observed position changes, and (iii) cross-venue position-change correlation above a third threshold.

7. The system of claim 1, wherein the probability manipulation detector computes a real-time distortion magnitude as the absolute difference between the inverse-variance-weighted fused probability estimate and a corresponding calibrated probability surface value, generates a probability manipulation candidate event when the distortion magnitude exceeds a distortion threshold and persists above the distortion threshold for longer than a persistence window, and weights the candidate event confidence score by a directional alignment score between the distortion direction and a net position change direction of a flagged participant entity or cluster.

8. The system of claim 1, wherein the liquidity spoofing detector monitors order lifecycle data within the venue microstructure history and computes, for each participant, a cancel-before-fill rate, a pre-cancellation order book depth impact, and a post-cancellation probability price mean reversion statistic, and generates a liquidity spoofing candidate event when the cancel-before-fill rate, the pre-cancellation order book depth impact, and the post-cancellation probability price mean reversion statistic each exceed corresponding detection thresholds.

9. The system of claim 1, wherein the cross-venue Sybil attack detector constructs a behavioral fingerprint vector for each participant identity, the behavioral fingerprint vector comprising an order timing distribution signature, a position sizing distribution signature, a market selection preference vector, and a response latency signature, and generates a cross-venue Sybil attack candidate event for identity pairs exhibiting cosine similarity above a similarity threshold across all fingerprint dimensions and exhibiting non-overlapping activity windows on two or more venues.

10. The system of claim 1, wherein the insider trading detector evaluates, for each information-release event in a maintained information-release event timeline, a pre-release temporal window and a post-release temporal window, computes for each participant or cluster an anomaly score normalized to a baseline distribution of position changes for similarly situated participants, and generates an insider trading candidate event when the anomaly score exceeds an anomaly threshold and exhibits directional alignment with the eventual information-release direction, wherein the insider trading detector consumes a calibrated insider-risk indicator received in cryptographically attested form from a companion verified prediction confidence scoring engine and does not itself compute said calibrated insider-risk indicator.

11. The system of claim 1, wherein the participant identity graph is maintained as a directed weighted graph over Pedersen commitments to participant identity values, each edge weight representing a probability-normalized transaction volume between participant pairs aggregated over a rolling temporal window, graph topology updates being computed incrementally within the TEE from each validated consolidated attestation record without exposing graph state to a host operating system.

12. The system of claim 1, wherein the adversarial alert record comprises an alert record identifier, an alert confidence level derived from the ensemble adversarial alert score, a list of contributing adversarial event types, a list of affected venue identifiers, a temporal evidence window, a list of Pedersen commitments to affected participant identity values, the platform master attestation quote from the triggering consolidated attestation record, the TEE remote attestation quote of the surveillance system, and a hash-based message authentication code over the preceding fields computed with a key sealed within the TEE and accessible only to a current enclave measurement.

13. The system of claim 1, wherein the zero-knowledge regulatory reporting engine generates a selective disclosure package comprising participant identity values and Pedersen commitment opening randomness encrypted under a regulatory authority registered enforcement public key, the zero-knowledge regulatory reporting engine being configured to verify a valid, non-revoked enforcement credential against a credential revocation list signed by a governance authority prior to transmission of the selective disclosure package.

14. The system of claim 1, further comprising an adaptive classifier governance module configured to verify that a classifier update package is signed by a quorum satisfying a multi-signature threshold requirement, to execute a shadow evaluation period during which a candidate classifier operates in parallel with production classifiers without production effect while a true-positive rate, a false-positive rate, and a latency metric are accumulated, and to promote the candidate classifier to production only upon a promotion approval by a quorum satisfying a promotion multi-signature threshold, each promotion event generating a model update record appended to an immutable governance audit log.

15. The system of claim 1, wherein the attestation ingestion interface rejects each consolidated attestation record failing any of a cross-exchange consistency score minimum threshold, a timestamp freshness threshold, and a venue completeness ratio minimum threshold with a validation failure event, and emits a cryptographically signed administrative-degradation notification when a validation failure rate within a rolling temporal window exceeds a configurable degradation threshold, and wherein a validation failure event is not treated as an adversarial event.

16. The system of claim 1, wherein the cryptographic alert sealing subsystem appends each adversarial alert record to an immutable append-only audit log protected by TEE-verified hash chaining such that modification of any sealed entry causes verification failure of all subsequent entries, and periodically publishes a signed audit-log root to an externally verifiable bulletin or consortium distributed ledger, the signed audit-log root being anchorable to a public blockchain at a configurable cadence.

17. The system of claim 1, wherein the adversarial alert record and the regulatory submission are each formatted such that a relying party comprising a regulator or institutional counterparty verifies the TEE remote attestation quote of the surveillance system bound thereto against a hardware-vendor attestation service and verifies the cryptographic commitments contained therein, thereby confirming that the adversarial event evidence was produced by the measured surveillance code base operating within a genuine hardware-protected enclave, without participation of, or reliance on representations by, an operator of the prediction market exchange and without the relying party instantiating a Trusted Execution Environment at infrastructure of the relying party.

18. The system of claim 1, wherein the hardware-protected enclave is instantiated on at least one of Intel Software Guard Extensions, Intel Trust Domain Extensions, AMD Secure Encrypted Virtualization-Secure Nested Paging, ARM Confidential Compute Architecture, and a cloud-provider confidential virtual machine, attestation quotes from heterogeneous Trusted Execution Environment platforms being verified against a multi-vendor attestation federation policy provisioned at enclave initialization.

19. The system of claim 1, wherein the signed action recommendation record transmitted by the circuit-breaker interface is integrated by the prediction market orchestration system into a compliance workflow of a regulated prediction market venue, the prediction market orchestration system retaining decisional authority over circuit-breaker execution and logging both the received signed action recommendation record and a disposition thereof in a hardware-attested audit trail, whereby the regulated prediction market venue obtains an independently verifiable record of adversarial-event disposition usable to evidence compliance with applicable market-integrity obligations.

20. The method of claim 2, wherein maintaining the rolling behavioral state comprises maintaining the calibrated probability surface as derived from attestation output produced by a companion verified prediction calibration system, and wherein the method further comprises appending the cryptographically sealed adversarial alert record to an immutable append-only audit log protected by TEE-verified hash chaining and enabling a relying party to confirm temporal integrity of a past sealed adversarial alert record by verifying a Merkle inclusion proof against a published audit-log root and verifying the TEE remote attestation quote bound to the past record against a hardware-vendor attestation service.
